(19) United States
(12) Patent Application Publication
(10) Pub. No.: US 2025/0371360 A1
(43) Pub. Date: Dec. 4, 2025

(54) DYNAMIC QUANTIZATION

(71) Applicant: Advanced Micro Devices, Inc., Santa Clara, CA (US)

(72) Inventors: Harris GASPARAKIS, Nashua, NH (US); Dissanayaka Mudiyanselage Emil Manupa KARUNARATNE, Milton Keynes (GB)

(21) Appl. No.: 18/680,995

(22) Filed: May 31, 2024

(51) Int. Cl. G06N 3/09

(52) U.S. Cl. CPC G06N 3/09

(57) ABSTRACT

Embodiments herein dynamically calculate a scale/offset on a per tile (or per block) basis rather than on a per tensor or channel basis. This enables the scale to be determined in place in the compute unit (e.g., a workgroup)—e.g., without having to perform a second pass or retrieve data from main memory. The scale for the tile can be determined by the compute unit using different techniques. In one embodiment, the scale is determine from the data in the tile itself. In another embodiment, a historical scale could be used.

### TECHNICAL FIELD

Examples of the present disclosure dynamically calculate or update a scale/offset at various granularity levels, such as per tensor, per channel, per group, per tile, or per block.

### BACKGROUND

A well-known technique for accelerating training and inference of machine learning (ML) models is quantization where data is converted between different data types (e.g., from FP16 to FP8, or INT8, or to INT4 encoded in INT8). The scales/offsets are currently applied per tensor or per (output) channel, and they may be either statically known, or be calculated dynamically (specifically for activations, and in full generality). However, in order to be able to calculate dynamic scales of the activations, either per tensor, or per (output) channel, what is necessary is knowledge of all the values in a filter plane, or the values for the whole tensor. Realistically, this requires a second pass on the data as a separate kernel, as it is hardly ever the case that all the necessary data is known in place, as they are calculated. That is, the system has to perform another pass on the data, after they all the values been processed, in order to deduce dynamic activation scales, and apply them, either for quantizing or requantizing a float point representation to reduced precision (for example for leveraging increased calculation throughput of the lower precision datatypes), or conversely, for dequantizing the results so that float point processing (such as application of a non-linear function) can take place. This second pass can have a significant negative performance impact on executing the ML model.

### SUMMARY

One embodiment herein is a compute unit that includes memory configured to store a first input that includes subset of data in a tensor, a channel, or a head and a matrix multiplier including circuitry configured to multiply the first input with a second input to generate a resulting matrix. The compute unit is configured to derive a per tile scale and perform a quantization operation, using the per tile scale, on at least one of the first input or the resulting matrix.

One embodiment herein is a hardware accelerator that includes a plurality of compute units, each including circuitry and registers where the registers of each of the plurality of compute units are configured to store a respective first input includes a different subset of data in a tensor, a channel, or a head. The circuitry in each of the plurality of compute units is configured to perform an operation in a machine learning (ML) model using the first input to generate resulting data, determine a per tile scale, and perform a quantization operation, using the per tile scale, on at least one of the first input or the resulting data.

One embodiment herein is a computing system includes a processor, memory configured to store a training or inference application for a ML model, and a compute unit. The compute unit includes memory configured to store a first input that includes subset of data in a tensor, a channel, or a head and a matrix multiplier including circuitry configured to multiply the first input with a second input to generate a resulting matrix as part of executing the training or inference application. The compute unit is configured to determine a per tile scale and perform a quantization operation, using the per tile scale, on at least one of the first input or the resulting matrix.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of a computing system for executing a machine learning application, according to one embodiment.

FIG. 2 is a flowchart for performing quantization using a dynamic per tile scale, according to one embodiment.

FIG. 3 illustrates performing quantization after a matrix multiplication, according to one embodiment.

FIG. 4 illustrates performing quantization before a matrix multiplication, according to one embodiment.

FIG. 5 illustrates a compute unit for performing quantization, according to one embodiment.

FIG. 6 illustrates an attention function for a transformer model, according to one embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described

Embodiments herein dynamically calculate a partial scale/offset on a per tile basis rather than on a per tensor or per channel basis or per head basis. This enables the scale to be determined in place in, e.g., a single compute unit (e.g., a workgroup) and applied in place—e.g., without having to perform a second pass and retrieve data from main memory, or without separately determining a scale for the entire tensor/channel/head. For example, a compute unit (which can also be referred to as a processing tile) may perform a matrix multiplication (which is part of an activation or attention) on a subset of data in a tensor, channel, or head. This subset of data, or the result of performing the matrix multiplication, can be referred to as a tile (or a block). This tile (e.g., the input into the compute unit, or the output of the compute unit) can then be quantized using the scale.

The scale for the tile can be dynamically determined by the compute unit using different techniques. In one embodiment, the scale is determined from the data in the tile itself, such as calculating a mean, min/max, and the like. In another embodiment, a historical scale could be used. For example, in a previous execution, the ML model may have determined a scale for a tensor/channel/head. This historical scale can then be used to dynamically scale the tiles derived from the tensor/channel/head. Moreover, this historical scale can be updated as the ML model continues to execute. Tiles (or blocks) of some activations (per channel) are known together, because they are calculated together in the same workgroup. In that case, quantization can be performed using a dynamical scale on a per tile basis in place at a compute unit or workgroup, without requiring a second pass.

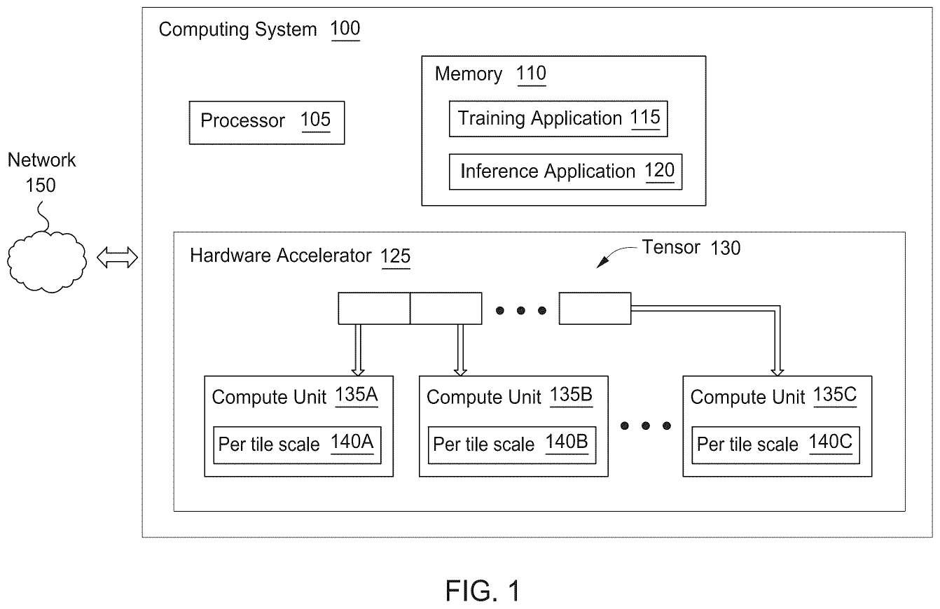

FIG. 1 illustrates a block diagram of a computing system 100 for executing a machine learning application, according to one embodiment. The compute system 100 can be a single computing device or multiple computing devices. For example, the computing system 100 could be a single server, edge device, or user device (e.g., a laptop, smart phone, tablet, etc.). Or the computing system 100 could be a cluster of computing devices, e.g., computing resources in a cloud computing environment which use the network 150 to receive ML tasks. Regardless of the particular implementation of the computing system 100, it can benefit from the quantization techniques described herein by reducing the amount of resources used to execute the ML model and/or by conserving power.

The computing system 100 includes a processor 105 which can represent any number of processing elements (e.g., central processing units (CPUs) with any number of processing cores). While FIG. 1 illustrates primarily executing a ML model in a hardware accelerator, the ML model may be executed in the processor 105 (e.g., one or more CPUs). The techniques for determining a per tile scale can also apply when using a CPU to execute a ML model. Further, the term “tile” does necessarily imply a 2D arrangement as a tile can be a multi-dimensional range in a multi-dimensional tensor. Processing is happening per tile, however scales within the tile could be defined either: (1) for the whole tile; or, for slices within the multi-dimensional tile. In the case of the attention example, scales would be applied per row/column within the tile.

The computing system 100 further includes memory 110 (e.g., main memory or storage) which can contain non-volatile memory, volatile memory, and combinations thereof. The memory 110 stores a training application 115 and an inference application 120 (e.g., software applications). The training application 115 can be used to train the ML model, while the inference application 120 can be used to execute the trained ML model to output a useful result.

For example, the training application 115 can provide training data to the ML model in order to determine weights from the layers in the ML model. The quantization techniques discussed herein can be used when training the ML model. For example, the ML model may be a floating point (FP) model which the developer may want to quantize into a integer model. The training application 115 can perform quantization after the training is complete (i.e., post training) where the ML model is first trained as an FP model and then quantized. Alternatively, quantization aware training can be performed where the weights are FP values and are updated as FP values, but then quantized into integer values such that the ML model ends up have integer weights. Alternatively, the weights could start as integer values (e.g., INT8) but the calculations performed during training could be done using FP16 values.

Quantization can also be used during inference, which was the original purpose of quantization. Ideally, the inference application 120 would like to identify a quantization scale (or offset) for a particular tensor, channel, head, or row of a matrix and then use it every time that data is processed in the ML model. However, the problem is that activations can have histograms with different ranges. For example, if each channel in a tensor has a similar dynamic range, the same scale could be used for the entire tensor, but it is often the case the channels in a tensor (or a matrix) have different histograms with very different dynamic ranges. While per channel output scales can be used, as mentioned above, since the output data is spread across multiple compute units or workgroups, a second pass is required to dynamically determine these scales. Instead, the embodiments herein can determine scales on a per tile basis—i.e., the data being processed by a single compute unit or workgroup—which does not require a second pass or additional access to main memory.

The hardware accelerator 125 can be any variety of different types of accelerators. The accelerator 125 can be a graphics processing unit (GPU), a field programmable gate array (FPGA), a system on a chip (SoC) that includes an array of artificial intelligence (AI) engines, and the like. In this example, the hardware accelerator 125 includes a plurality of compute units 135 that can perform operation on a tensor 130 of data using the ML model in parallel. The compute units 135 are not limited to any particular type of circuitry or compute elements. For example, if the hardware accelerator 125 is a GPU, the compute units 135 may include vector processors (e.g., single instruction, multiple data (SIMD)) or streaming multiprocessors (SM) and memory (e.g., registers). Moreover, the compute units 135 can be assigned to workgroups by a programmer to execute wavefronts. In other examples, one or more compute units 135 may be assigned to a kernel. If the hardware accelerator 125 is a FPGA, the compute units 135 may be formed using programmable logic (in contrast to hardened circuitry or hardened logic).

FIG. 1 illustrates that the tensor 130 can be divided into different subsets (e.g., tiles or blocks) that are transmitted to respective compute units 135 for processing. For example, the tensor 130 may be a particular row of a matrix, where each compute unit 135 receives a different chunk of the row to perform an operation using a second input (not shown) such as a matrix multiplication. While the tensor 130 may be stored in main memory in the hardware accelerator 125 or the memory 110, the subsets of the tensor 130 is stored in the memory (e.g., registers) in the compute units 135.

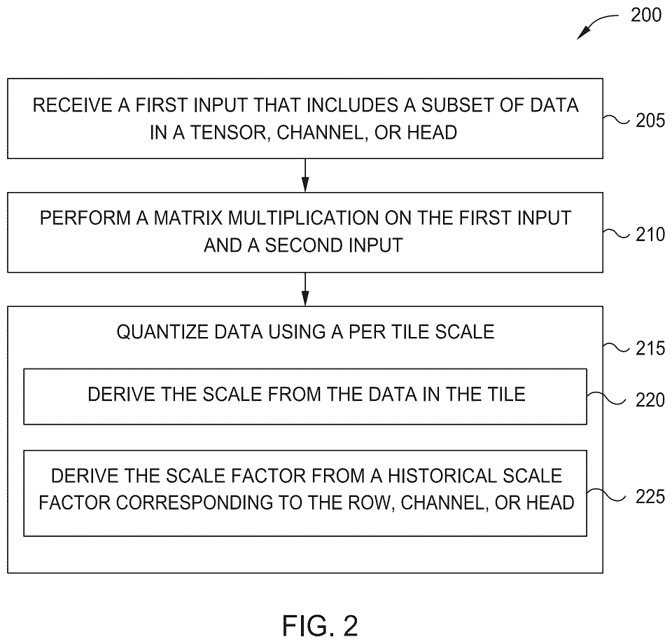

Each computing unit 135 stores a per tile scale 140. These scales 140 may be different, or could be the same value. In one embodiment, the scales 140 are calculated from the subsets of the tensor 130, or from the result of performing an operation such as a matrix multiplication. In another embodiment, the scales 140 are derived from historical scales such as previous matrix multiplications performed using the tensor 130. In any case, these scales 140 are performed on a per tile basis to quantize the data, rather than performing quantization on the entire tensor 130 (or channel or head in the tensor 130). The operations of the compute unit 135 are described in more detail in FIG. 2.

FIG. 2 is a flowchart of a method 200 for performing quantization using a dynamic scale, according to one embodiment. In one embodiment, the method 200 is performed by a compute unit (e.g., one of the compute units 135 in FIG. 1) which can be part of a workgroup or a kernel. However, the discussion below simply refers to the compute unit, but can apply to a workgroup or kernel.

At block 205, the compute unit receives a first input that includes a subset of data in a tensor, channel, or a head. For example, the first input can be a tile or block. In one example, the tensor may be a row of a matrix or a tensor of weights. Different compute units may be given different subsets of the tensor, channel, or head for processing. This can be due to memory constraints in the compute units. For example, the compute units may not have sufficient memory (e.g., sufficient register space) to store the entire tensor, channel, or head, and calculate an output.

At block 210, the compute unite performs a matrix multiplication on the first input and a second input. For example, the matrix multiplication may be between queries (Q) and keys (K) as part of attention or an activation function. Moreover, the second input can also be a subset of a tensor, channel, or head.

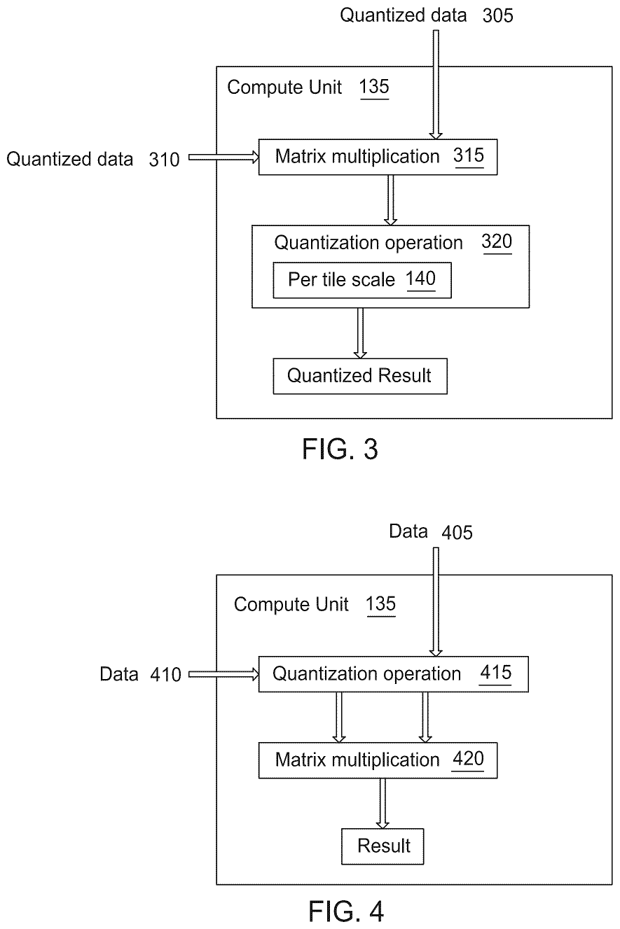

At block 215, the compute unit quantizes data using a per tile scale. In one embodiment, this quantization can be performed on the first input or the second input before the matrix multiplication is performed. That is, the quantization described at block 215 can be performed before block 210. This is discussed in more detail in FIG. 3. In another embodiment, this quantization is performed on the result of the matrix multiplication (which can also be referred to as a tile), e.g., after the matrix multiplication is performed. This is discussed in FIG. 4.

In yet another embodiment, quantization may be performed both before and after the matrix multiplication at block 210. Further, the quantization at block 215 can be a quantization operation where the per tile scale is used to convert the data from a higher precision data type to a lower precision data types (e.g., from FP32 to FP8, from FP8 to INT8, from INT16 to INT8, etc.). Alternatively, the quantization at block 215 can be a de-quantization operation where the per tile scale is used to convert the data from a lower precision data type to a higher precision data types (e.g., from FP16 to FP32, from INT8 to FP8, from INT8 to INT16, etc.). Thus, performing quantization at block 215 can include a quantization operation where data precision is reduced or a de-quantization operation where data precision is increased.

In one embodiment, the blocks 210 and 215 can be performed using the same kernel executing on the compute unit. However, in another embodiment, blocks 210 and 215 can be performed on two different kernels executing in the compute unit. That is, a first kernel can derive or determine the per tile scale while a second kernel performs the quantization operation. For example, the first kernel may calculate min/max, an average, a variance, etc. and the per tile scales as an output fusion at the end of the first kernel to calculate the activations. The second kernel can then perform the quantization as an input fusion. In one embodiment, a kernel is scheduled to be executed in the hardware and comprises multiple workgroups that are scheduled in multiple compute units. Dispatch can be used interchangeably with kernel in this disclosure.

FIG. 2 illustrates two techniques for determining the per tile scale to perform quantization. At sub-block 220, the compute unit derives the per tile scale from the data in the tile. This can include deriving the scale factor from the first and second inputs or from the output of the matrix multiplication. For example, the compute unit can derive a first scale from the first input and a second scale from the second input. These scales can then be used to quantize/de-quantize the inputs before performing the matrix multiplication. Alternatively, the compute unit derives the scale from the result of the matrix multiplication, which then can be used to quantize/de-quantize the results of the matrix multiplication.

Per tile scales may also lead to higher accuracy, especially in cases where the histogram of the activations are not uniform in each tile. A per tile scale can lead to higher accuracy of quantization (i.e. less accuracy loss) by allowing each tile to contribute to the final result in a way that does not underflow (or overflow) and ensuring that the local scales are set appropriately for each tile.

The embodiments herein are not limited to any particular method for calculating the scales. For example, the compute unit can calculate a mean of the inputs or the output to use as the scale. Or the compute unit can use min-max of the inputs or the outputs as the scale, which determines the full dynamic range of the data, and sets the scale to map the whole dynamic range to the quantized datatype's range. An alternative technique would be to accept outliers that should be truncated, however increasing the sensitivity of the mapping. In such a case, an outlier would not necessarily fully expand the dynamic range used for scaling, but potentially only expand it in the right direction, by a percentage. But these are just examples as there are multiple suitable algorithms for determining the quantization scales.

As another example for determining the per tile scale, at sub-block 225 the compute units derive the scale from a historical scale corresponding to the tensor (e.g., a row of a matrix), channel, or head. In this embodiment, this scale may not be derived from the current data, but rather could be derived for historical data which is then applied to quantize the current data in the compute unit (e.g., to quantize the first/second inputs or the result of the matrix multiplication). For example, the historical scale may be derived from previous outputs of the matrix multiplication. For instance, each time the compute unit performs a matrix multiplication using the first input (where the second input changes), the compute unit updates the historical scale which can then be used to scale the next matrix multiplication that uses the first input.

In another embodiment, the per tile scale is derived using a historical scale and the current data. For example, the mean or min-max of the current data in the tile could be identified and then combined with the historical scale. This combined scale could then be used to scale, for example, the result of the matrix multiplication.

One embodiment for updating the max value of the range to derive the scale could be:

$$δ {V}_{m ax} = V > {V}_{m e a n} ? α ( V - {V}_{m ax} ) : 0$$

$$δ {V}_{m i n} = V < {V}_{m e a n} ? α ( V - {V}_{m i n} ) : 0$$

$$δ {V}_{mean} = \frac{V - {V}_{mean}}{N}$$

$$δ N = 1$$

In the equations above, V is the current sample (e.g., the current tile), Vmax, Vmin, Vmean are the current max, min, and mean values respectively, and δVmax, δVmin, and δVmean are the corresponding updates, after having seen N samples. Alpha is a percentage of how aggressive the statistics are updated. This can be further estimated from the data.

While the historical scale could be derived from previous execution of the tile, this may be less preferred then using a historical scale derived from a tensor/channel/head, which are typically much larger data sets. A historical scale derived from previously tiles processed by the compute little may be too small of a sample size to provide a robust scale for the current tile.

The examples above can be used to predict dynamic scales, so that data can be quantized and de-quantized in place from estimates of scales, thereby avoiding having to read the data first to calculate the correct scales. As mentioned above, this is especially useful in cases where the data for a tensor/channel/head does not fit in the compute unit. Within the compute unit, the scale can be dynamically determined in place (by directly calculating it or determining it using historical scales), and then the tile or block is quantized in place, without having to load the data again from global memory (i.e. the data is already in registers, e.g., in a GPU workgroup).

FIG. 3 illustrates performing quantization after a matrix multiplication, according to one embodiment. As shown, the compute unit 135 receives quantized data 305, 310 as first and second inputs. That is, the data has already been quantized from a higher precision data type to a lower precision data type. The compute unit 135 then performs a matrix multiplication 315 on the quantized data 305, 310.

The results of the matrix multiplication are then quantized/de-quantized by the quantization operation 320. That is, the quantization operation 320 uses the per tile scale 140 to quantize/de-quantize the results of the matrix multiplication. For example, the quantized data 305, 310 may be INT8 data, which when multiplied, results in INT32 data. In one embodiment, the per tile scale 140 can be used to de-quantize the result from INT32 to INT8 so it can be, e.g., fused with another matrix that is INT8 in a later operation. In another embodiment, the per tile scale 140 can be used to de-quantize the result from INT32 to FP32 to perform, e.g., a softmax operation or non-linear activation functions such as tanh, sigmoid, etc. In either case, the per tile scale 140 can be determined using any of the techniques described at the sub-blocks 220 and 225 in FIG. 2.

FIG. 4 illustrates performing quantization before a matrix multiplication, according to one embodiment. As shown, the compute unit 135 receives non-quantized data 405, 410 as first and second inputs. The compute unit 135 then performs a quantization operation 415 on the non-quantized data 405, 410 to convert it to a lower precision data type (e.g., from FP32 to INT32, from FP16 to FP8, etc.) or convert it to higher precision data type (e.g., from INT to FP or from FP8 to FP16).

The quantized versions of the data 405 and 410 are then used as inputs for the matrix multiplication 420 to generate a result 425.

While not shown, another quantization operation can be performed on the result 425. This could be done using the same scales or a different scale relative to the quantization operation 415. Thus, a quantization operation could be performed before and after the matrix multiplication 420. This could also apply to FIG. 3 where quantization operations can be performed on the quantized data 305, 310 before the matrix multiplication 315.

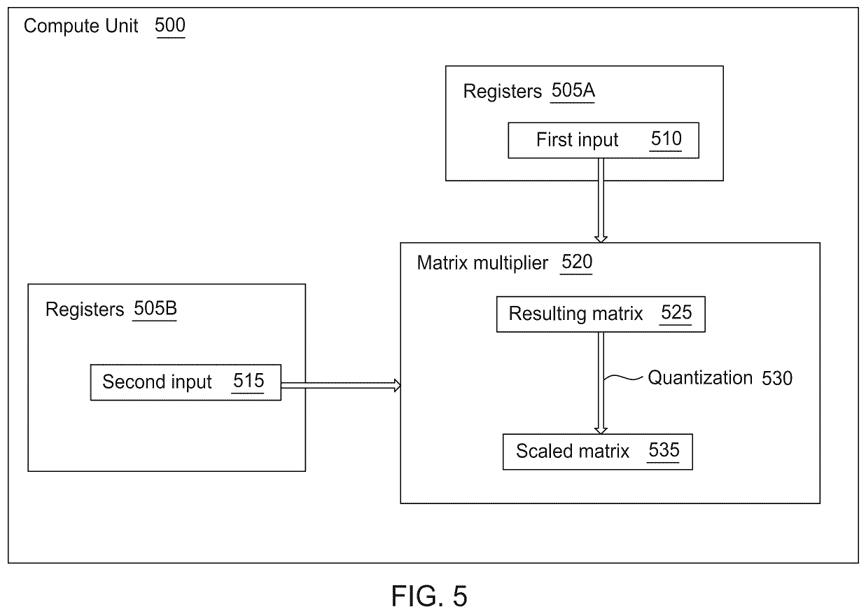

FIG. 5 illustrates a compute unit 500 for performing quantization, according to one embodiment. The compute unit 500 illustrates registers 505A for storing first input 510 and second registers 505B for storing second input 515. As mentioned above, the registers 505 may not be sufficient to hold a larger data set, such as an entire tensor, entire channel, or entire head, or the registers 505 may not be large enough to store the results of performing a matrix multiplication if the entire tensor/channel/head were used as inputs in the matrix multiplication.

A matrix multiplier 520 (e.g., circuitry) performs a matrix multiplication using the first and second inputs 510, 515 to generate a resulting matrix 525. Although not shown, the resulting matrix 525 may also be stored in the registers 505.

In this example, quantization 530 is performed on the resulting matrix 525, which can be a quantization operation or a de-quantization operation using a per tile scale (not shown). Performing quantization 530 results in a scaled matrix 535. In this manner, FIG. 5 illustrates exemplary hardware (e.g., registers 505 and a matrix multiplier 520) for performing quantization 530 using a per tile scale.

Moreover, while FIG. 5 illustrate performing quantization 530 after matrix multiplication, as discussed above, quantization can be performed on the first and second inputs 510, 515 before performing matrix multiplication.

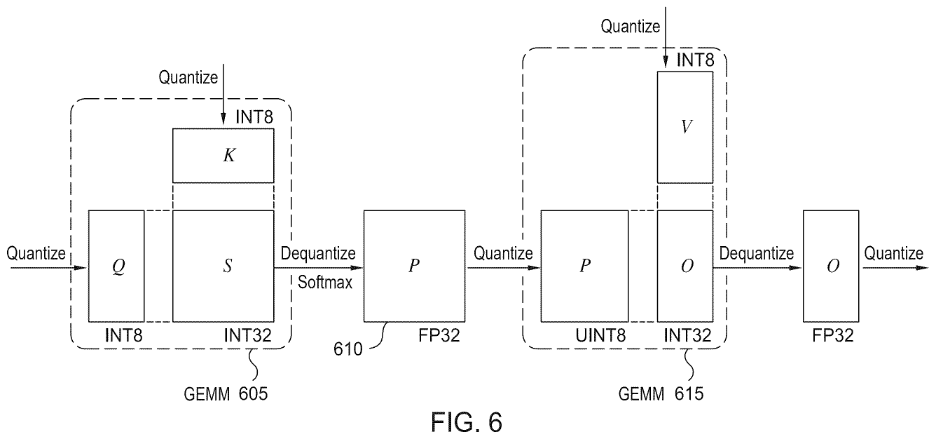

FIG. 6 illustrates performing attention for a transformer model, according to one embodiment. This disclosure introduces the concept of per tile quantization as a means to implement fully quantized pipelines. This scheme introduces scales that are not uniform per input channel, but rather are applied per tile, and possibly per row (or per channel) per tile. Embodiments herein describe how to dynamically quantize per tile, and in-place, so that the low precision datatype Matrix Fused Multiply Add (MFMA) operations can be leveraged. In the discussion below, flash attention is used as an example.

MFMA instructions can include a multiply/add INT8 operands, to produce INT32, or FP8 operands, to produce FP32, at which point a non-linear function is applied, and the data is converted back to FP8, using a quantization scale. This quantization scale is usually a part of the ML model, and most ML frameworks support setting that scale, either per tensor, or per channel. Quantization may also involve setting a “zero point”, which corresponds to what quantized low precision number corresponds to 0 in floating point arithmetic:

$$Xfp = Sfp ( Xq - Zq ) \qquad ( 1 )$$

$$Xq = clip ( Xfp / Sfp + Zq ) \qquad ( 2 )$$

As mentioned before, the scales can be pre-calculated either in a post training step (PTQ: post training quantization), or during training (QAT: quantization aware training), and saved with the model. However, the embodiments herein calculate the scales dynamically, “per tile”, or “per tile per row”, or “pre tile per channel”. This is very appropriate for microscaling floating point (MXFP) datatypes (discussed below), where the “tile” is to be thought of as the MXFP “block”. Another use case is situations where dequantization and requantization happens in a block or tile manner in order to accommodate a hardware accelerated implementation where there is not sufficient register space in a compute unit (or processing tile) as discussed above. One example of this is Flash 2.0 attention, as explained below.

The attention algorithm is as follows:

First, the dot product of the Queries (Q) with the Keys (K) is calculated. The Queries are partitioned into blocks, and Keys are partitioned into tiles. In one example, a workgroup (e.g., a GPU workgroup) iterates over the Key tiles, and calculates the dot products of the Query block with each key tile, as shown in Equation 3, where we calculate the matrix of dot products between the Query block, and the Key tile i to result in S, which can be performed by a General Matrix Multiplication (GEMM) unit 605 in FIG. 6. In all that follows, matrices, or (2D) matrix blocks are denoted with bold face font.

$${S}^{( i )} = {{Q}^{( i )} ( {K}^{( i )} )}^{T} \qquad ( 3 )$$

Once the data for each Key tile are loaded into the workgroup's memory (or compute unit's memory), for each row in the query block, the workgroup calculates auxiliary data, as described in what follows. The per row per tile data can be denoted as vectors:

$${\vec{μ}}^{( i )} = min ( {S}^{( i )} ) \qquad ( 4 )$$

Equation 4 calculates the minimum of the S(i) across each row in tile i. Therefore, each row (as many rows as the rows of the query block handled by the compute unit) calculates this minimum, for each tile. Similarly, the maximum per tile per row is shown in Equation 5:

$${\vec{m}}^{( i )} = max ( {S}^{( i )} ) \qquad ( 5 )$$

As the iteration over tiles of the key matrix proceeds, and to maintain compatibility with the original Flash attention implementation, the value of the running per row maximum, across each of the tiles that has been processed so far, is maintained:

$${\vec{M}}^{( i )} = max ( {\vec{M}}^{( i - 1 )} , {\vec{m}}^{( i )} ) \qquad ( 6 )$$

Equation 6 calculates the running max (per row) of tile i, denoted as \vec{M}⁽ⁱ⁾, from the local max of tile i, denoted by \vec{m}⁽ⁱ⁾, and the global max of the previous tiles, denoted by \vec{M}⁽ⁱ⁻¹⁾ (the running max can be initialized to a vector of zeros, on each block of rows of queries).

The global max across all tiles is calculated, to be used in softmax, where the maximum value of the row is subtracted from all logits, to avoid overflow in the softmax calculation, which is illustrated as the P operation 610 in FIG. 6. The calculation of the local tile min, and the local tile max are used in order to calculate the range of the values of the exponentiated logits (but before the division with the sum of the exponents).

This exponentiation is defined in Equation 7,

$${A}_{FP}^{( i )} = {e}^{{S}^{( i )} - {\vec{M}}^{( i )}} \qquad ( 7 )$$

where A_{PP}⁽ⁱ⁾ is the exponentiation (i.e. a floating point arithmetic value) of each logit value in the tile, but with subtracting the running max across each row in the query block.

The range of values of A_{FP}⁽ⁱ⁾ in tile i is:

$${\vec{A}}_{m i n}^{( i )} = ( 1 - {λ}_{1} ) \cdot {e}^{{\vec{μ}}^{( i )} - {\vec{M}}^{( i )}} \qquad ( 8 )$$

$${\vec{A}}_{m ax}^{( i )} = ( 1 - {λ}_{2} ) \cdot {e}^{{\vec{m}}^{( i )} - {\vec{M}}^{( i )}} \qquad ( 9 )$$

In one embodiment, the λ in Equations 8 and 9 serves as a limiting factor, to avoid going all the way to the extreme. It can be set to, e.g., λ=0.1.

The next step in the algorithm in flash attention is to calculate the softmax, per tile, in an iterative process. One proposed algorithm is:

$${\vec{l}}^{( 1 )} = {\sum }_{i} {\vec{A}}_{i}^{( 1 )} \qquad ( 10 )$$

$${\vec{l}}^{( j )} = {e}^{{\vec{M}}^{( i - 1 )} - {\vec{M}}^{( i )}} {\vec{l}}^{( j - 1 )} + {\sum }_{i} {\vec{A}}_{i}^{( j )} \qquad ( 11 )$$

Equations 10 and 11 describe the summation of the exponents of the logits, with iterative corrections to compensate for each tile having a different mean value, which is subtracted in the exponent. The final part of the calculation is to perform a tile-wise multiplication, with tiles of the V matrix, which can be done using a GEMM unit 615 in FIG. 6.

$${O}^{( 1 )} = \frac{{A}^{( 1 )}}{{\vec{l}}^{( 1 )}} \cdot {V}^{( 1 )} \qquad ( 12 )$$

$${O}^{( j )} = \frac{{\vec{l}}^{( j )}}{{\vec{l}}^{( j - 1 )}} {O}^{( j - 1 )} + \frac{{A}^{( j )}}{{\vec{l}}^{( j )}} \cdot {V}^{( j )} \qquad ( 13 )$$

In Equations 12 and 13 there are two contributions: A contribution calculated from the current j tile:

$$δ {O}^{( j )} ≡ \frac{{A}^{( j )}}{{\vec{l}}^{( j )}} \cdot {V}^{( j )} \qquad ( 14 )$$

and also an adjustment to the values calculated from the previous tiles, to compensate for the different max values per tile.

It is desirable to efficiently implement the matrix multiply in Equations 12 and 13, in the case where the data is quantized, directly on the quantized datatypes. To that effect, it is desirable to convert the operands to quantized datatypes (e.g., INT8, FP8, etc.), without retouching the data yet again, i.e., without actually doing the division of shown in Equation 14 as a separate step.

To achieve this, matrix A can be quantized in place, when the matrix is calculated. There are two approaches: one is using signed datatypes for quantization (e.g. INT8), even in situations where an unsigned datatype would be possible (e.g. UINT8). This may be a bit more wasteful than the next approach. Another approach would be to make maximal use of the bits in the quantization datatype, which may define a zero offset. Both approaches are explained in what follows.

### Symmetric Quantization

Even though the results of softmax are explicitly positive, they can still be encoded as INT8 (or FP8), even though this uses one of the bits to encode the sign. In effect, this stretches the positive range of the output of softmax in the [0,127] range of an INT8 datatype. This is advantageous because the V matrix may also be quantized to INT8 (FP8, respectively), and many hardware implementations only support INT8 (FP8) by INT8 (FP8) operations.

In that case, and using Equations 8 and 9, the dynamic per tile scale DS (assuming no zero offset), for tile i, is defined as:

$${\vec{D S}}^{( i )} = \frac{{\vec{A}}_{m ax}^{( i )} - {\vec{A}}_{m i n}^{( i )}}{127} \qquad ( 15 )$$

In one embodiment, the vector index in the equation above is a row index, i.e., each row can have a different scale. But this is not necessary, we could also consider a single scale across all the rows of the tile.

Equations 12 and 13 can be modified using Equation 15 to result in:

$$\frac{{A}^{( i )}}{{\vec{l}}^{( i )}} \cdot {V}^{( i )} \to \frac{( {A}^{( i )} / {\vec{D S}}^{( i )} ) \cdot {V}^{( i )}}{( {\vec{l}}^{( i )} / {\vec{DS}}^{( i )} )} \qquad ( 16 )$$

More explicitly:

$${A}_{( q ) ab}^{( i )} = QType ( {A}_{ab}^{( i )} / {DS}_{a}^{( i )} ) \qquad ( 17 )$$

$${l}_{( q ) a}^{( i )} = {l}_{a}^{( i )} / {DS}_{a}^{( i )} \qquad ( 18 )$$

Equation 17 defines the quantized A matrix by typecasting the result of the quantization using the per tile per row scale DSₐ⁽ⁱ⁾, as appropriate. For example, typecasting to INT8, or FP8. Similarly, Equation 18 redefines the partial sums of each row (per tile) of the A matrix, with the same scale.

Therefore, the direct contribution of each tile i in the attention calculation is:

$$δ {O}_{a c}^{( i )} = {\sum }_{b} \frac{{A}_{( q ) a b}^{( i )} {V}_{b c}^{( i )}}{{l}_{( q ) a}^{( i )}} \qquad ( 19 )$$

In the above calculation, the matrix multiplication in the numerator may be performed using the platform's MFMA abilities. The resulting type, typically INT32 in the case of INT8 MFMA, or FP32 in the case of FP8 MFMA, can then be de-quantized or re-quantized in place, using the per row per tile scales (a row in a particular tile).

### Asymmetric Quantization

Considering that the output of softmax, in one embodiment, is always positive by definition, it may be more beneficial to implement asymmetric quantization, i.e. by defining a zero offset.

In that case, and referring back to Equation 1, the maximum float value XM is mapped to the max quantized value (e.g. 127, in the case of INT8), and the min floating value X_{fp}^{m} is mapped to the min quantized value (e.g. −128, in the case of INT8, although it may be slightly more convenient to use −127, for symmetry with the positive values, and which is what is used in what follows).

The value of the scale S and zero offset Z can be determined by solving the system of equations below. Note that the sign of the zero offset is changed in the definition, to avoid carrying negative signs around.

$${X}_{fp}^{M} = {S}_{fp} ( 127 + {Z}_{q} ) \qquad ( 20 )$$

$${X}_{fp}^{m} = {S}_{fp} ( - 127 + {Z}_{q} ) \qquad ( 21 )$$

The solution is:

$${S}_{fp} = \frac{{X}_{fp}^{M} - {X}_{fp}^{m}}{254} \qquad ( 22 )$$

$${Z}_{q} = QType ( \frac{{X}_{fp}^{M} + {X}_{fp}^{m}}{{S}_{fp}} ) = QType ( 254 \frac{{X}_{fp}^{M} + {X}_{fp}^{m}}{{X}_{fp}^{M} - {X}_{fp}^{m}} ) \qquad ( 23 )$$

The above formulae can be substituted in the float calculations for matrix A to implement asymmetric quantization per tile.

### General Use

The above mechanism of the tile dynamic quantization has general applicability to any calculation that is implemented in a “split-k” or a “stream-k” manner. The main point of split-k/stream-k implementations is to partition a loop into a nested loop. The inner loop loads data in a “batch”/“block”/“tile”, and operates on them in one go, and determines the register and local data share (LDS) usage requirements of the hardware implementation (e.g., GPU kernel). Each block in the split-k implementation can have its own per tile scale, which can also be determined dynamically.

There are at least two cases of interest for the dynamic scale determination. In many cases, the statistics of a tile are either known, or are calculated for other reasons (such as when implementing softmax) as discussed in sub-block 220 in FIG. 2. In that case, it is possible to quantize without an extra pass on the data, and that is the very important case of flash 2.0 attention, described in detail above. Furthermore, one could use a running calculation of the statistics from the previous tiles, as predictors for the statistics of the current tile (which was discussed in sub-block 225 in FIG. 2). Such calculations estimate moments of a distribution (e.g. mean, standard deviation, etc.) from adaptive algorithms, possibly also using momentum. In that case, most of the benefit of dynamic quantization is maintained (i.e. scales and offsets determined by the data), without the need to touch the data twice. As a quality of service metric, values of the data still lie within the current predicted ranges are validated, and if they do not, the ranges could be reset on the fly. This scheme could still use the predicted scales in most cases, while maintaining the flexibility of recalculating the scales (and touching the data twice).

The concept of using predictive statistics to determine quantization scales applies at various levels of granularity. At a coarse level, one could predict the quantization scale of a whole activation tensor, based on the statistics of that matrix in prior runs of a pipeline. Here, a run may correspond to an inference, or a training epoch (during training). We refer to this concept as historical quantization scale determination. It can either be in-place, while producing the activations in a layer, or when using them in a subsequent layer. One contribution of this work is to avoid having to do this as a separate process (which would be inefficient). The granularity of when scale calculation would take place could also be finer. For example, in attention layers of transformers, quantization scales could be determined per “attention head”. However, and with the same granularity as above, scales could be determined and updated, per processing tile, either starting from the historical scales in the same granularity, or at a coarser granularity. For example, scales of a attention head could be initialized from the scales of the whole query or key or value matrix (in attention layers), and further be refined dynamically, and preferably in-place.

For MXFP datatypes, these datatypes carry a common exponent for each block (e.g., each block of 32). For definiteness, in the flash attention use case, the Q, K, V matrices can be encoded with such datatypes, which includes a common exponent per block of 32. The result of contraction of Q*Kt will be a FP32 number, which should be “softmaxed” and then converted back to MXFP for further calculation of the matrix multiplication with V (also MXFP). The softmax implementation in FP32 can be identical, as described above, with the dynamic scales possibly be stored as the common exponents on the MXFP datatype.

As described herein, dynamic per group scales is new, and especially the implementation scheme that implements split-k/stream-k fusions of multiple layers with in-place quantization. The application to “flash attention 2.0” is also advantageous, and is accomplished without having to touch the data an extra time. The fusion may be explicit, as a single kernel, where the quantization/dequantization scales are produced in place, and used in the context of the same kernel. An alternative approach is to view the calculation of dynamic scales as fusions in a multikernel pipeline. Consider kernel 1 that produces data, that should be quantized, and then used by kernel 2. This quantization can be viewed as an “output fusion” of kernel 1: After kernel 1 produces the data, find the quantization scale and offset, and apply it in place to produce the quantized data, before writing it out to global memory, for kernel 2 to use them. In that case, kernel 1 should also encode the quantization scales in the output, either in a packed manner (quantized data followed by scale and offset), or in separate pointers. Kernel 2 can load the quantized data directly, as well as the corresponding scales and biases (which would be useful if kernel 2 performs a matrix operation and then dequantizes the data).

Dynamic quantization as an in-place operation is of interest in the case that the original data is still useful (for example in skip connections), and should be kept around, while a quantized version of the data should be used (e.g. within a residual block). In such a case, it may be beneficial to implement dynamic quantization as an input fusion, as follows: Consider kernel 1 that produces float point data, that is used as floating point data in a skip connection, but also is meant to be used as quantized data in a independent matrix operation, in kernel 2: In that case, it may be beneficial to implement an in place dynamic quantization in kernel 2, as an input fusion. However, in order to maximally accelerate this process, kernel 1 should not only produce the floating point results, but it can also produce useful metadata, such as the quantization scales and offsets, without actually performing the quantization.

Furthermore, dynamic quantization using predictive statistics on what the quantization scale is also advantageous, in any granularity, i.e., per block, or per row (in matrix multiplications), or per channel (e.g. in convolutions), or per block of channels.

The scheme of scale refinement is also advantageous: Refinement means using scales of a coarse granularity, as initial predictors of scales in a finer granularity (e.g. the scales of a whole matrix are predictors of the scales of a row of the same matrix). The coarser predictor could be historical, and the finer predictors could be dynamic, and they could also be used to update the predictors for next runs as discussed in sub-block 225.

The above scheme can also be applied for the emerging MXFP datatypes. For those datatypes, matrix MFMA operations act on blocks of MXFP data (which share a common exponent), but produce (i.e. accumulate into) a “normal” float numbers. Those numbers would typically need to be converted back to MXFP, to be used in subsequent stages of the pipeline.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A compute unit, comprising:
memory configured to store a first input that includes subset of data in a tensor, a channel, or a head; and
a matrix multiplier comprising circuitry configured to multiply the first input with a second input to generate a resulting matrix,
wherein the compute unit is configured to:
derive a per tile scale, and
perform a quantization operation, using the per tile scale, on at least one of the first input or the resulting matrix.

2. The compute unit of claim 1, wherein determining the per tile scale is performed without the compute unit having to separately determine a scale for an entire tensor, an entire channel, or an entire head.

3. The compute unit of claim 1, wherein the resulting matrix and the quantization operation are part of activation or attention of a machine learning (ML) model.

4. The compute unit of claim 3, wherein the quantization operation is performed to de-quantize the resulting matrix in order to perform at least one of a softmax operation that is part of attention of the ML model or a non-linear activation function.

5. The compute unit of claim 1, wherein determining the per tile scale comprises:
deriving the per tile scale from either the first input or the resulting matrix.

6. The compute unit of claim 5, wherein the per tile scale is derived from calculating the mean or the min-max of the first input or the resulting matrix.

7. The compute unit of claim 1, wherein determining the per tile scale comprises:
deriving the per tile scale from a historical scale corresponding to the tensor, the channel, or the head.

8. The compute unit of claim 1, wherein the compute unit is configured to execute a first kernel to determine the per tile scale and a second kernel to perform the quantization operation.

9. A hardware accelerator, comprising:
a plurality of compute units, each comprising circuitry and registers, wherein the registers of each of the plurality of compute units are configured to store a respective first input comprises a different subset of data in a tensor, a channel, or a head,
wherein the circuitry in each of the plurality of compute units is configured to:
perform an operation in a machine learning (ML) model using the first input to generate resulting data,
determine a per tile scale, and
perform a quantization operation, using the per tile scale, on at least one of the first input or the resulting data.

10. The hardware accelerator of claim 9, wherein determining the per tile scale is performed without having to separately determine a scale for an entire tensor, an entire channel, or an entire head.

11. The hardware accelerator of claim 9, wherein the operation in the ML model is part of activation or attention of the ML model.

12. The hardware accelerator of claim 11, wherein the quantization operation is performed to de-quantize the resulting data in order to perform a at least one of a softmax operation that is part of attention of the ML model or a non-linear activation function.

13. The hardware accelerator of claim 9, wherein determining the per tile scale comprises:
deriving the per tile scale from either the first input or the resulting data.

14. The hardware accelerator of claim 13, wherein the per tile scale is derived from calculating the mean or the min-max of the first input or the resulting data.

15. The hardware accelerator of claim 9, wherein determining the per tile scale comprises:
deriving the per tile scale from a historical scale corresponding to the tensor, the channel, or the head.

16. A computing system, comprising:
a processor;
memory configured to store a training or inference application for a ML model; and
a compute unit, comprising:
memory configured to store a first input that includes subset of data in a tensor, a channel, or a head; and
a matrix multiplier comprising circuitry configured to multiply the first input with a second input to generate a resulting matrix as part of executing the training or inference application,
wherein the compute unit is configured to:
determine a per tile scale, and
perform a quantization operation, using the per tile scale, on at least one of the first input or the resulting matrix.

17. The computing system of claim 16, wherein determining the per tile scale is performed without the compute unit having to separately determine a scale for an entire tensor, an entire channel, or an entire head.

18. The computing system of claim 16, wherein the resulting matrix and the quantization operation are part of activation or attention of the ML model.

19. The computing system of claim 16, wherein determining the per tile scale comprises:
deriving the per tile scale from either the first input or the resulting matrix.

20. The computing system of claim 19, wherein the per tile scale is derived from calculating the mean or the min-max of the first input or the resulting matrix.
